(19) United States
(12) Patent Application Publication
(10) Pub. No.: US 2009/0033620 A1
(43) Pub. Date: Feb. 5, 2009

(54) Portable Electronic Device and Touch Pad Device for the Same

(75) Inventors: Po-Kai Ko, Taipei (TW); Chi-Chung Ho, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTeK Computer Inc., Taipei (TW)

(21) Appl. No.: 12/177,466

(22) Filed: Jul. 22, 2008

(30) Foreign Application Priority Data
Jul. 31, 2007 (TW) 96128095

(51) Int. Cl. G06F 3/033; G06F 3/041

(52) U.S. Cl. 345/157; 345/173

(57) ABSTRACT

A portable electronic device includes a casing and a touch pad device. The casing has an opening. The touch pad device is mounted on the casing, and includes a touch pad, a support, a suspending device, and a sensing device. The touch pad is movable and exposed in the opening. The support is mounted on the casing. The suspending device is mounted between the touch pad and the support. The sensing device includes a plurality of sensing elements respectively mounted on the support correspondingly to the perimeter of the touch pad.

### RELATED APPLICATIONS

This application claims priority to Taiwan Application Serial Number 96128095, filed Jul. 31, 2007, which is herein incorporated by reference.

### FIELD OF THE INVENTION

The present invention relates to a portable electronic device, particularly to a touch pad device of a portable electronic device.

### BACKGROUND OF THE INVENTION

Portable electronic devices, such as a portable computer, have input devices to provide the user with means to input data. Generally, in addition to keyboards, touch pad devices are also input devices.

Existing touch pad devices comprise a touch pad, whereby a user may move a finger or fingertip thereon to move the cursor on the display screen of an electronic device. However, existing touch pads are directly installed and fixed on the casing of an electronic device, i.e., the touch pad is fixed and unmoving while the user's finger moves. In other words, existing touch pads are unable to provide a feeling of maneuverability.

Furthermore, when using an existing touch pad to move a cursor, the finger needs to be dragged back and forth to move the cursor or scroll. Users often need to repeatedly move their finger or fingertip back and forth when moving the cursor a long distance away to a target point, thereby increasing the inconvenience of the user.

### SUMMARY OF THE INVENTION

In one aspect of the present invention, a touch pad device is provided that may be used in a portable electronic device to solve the problems of existing touch pad devices having inconvenient application and a poor feeling of maneuverability.

According to the present invention, the touch pad device may be used in a portable electronic device with a displaying device and a casing. The touch pad device is used to control displacement of the cursor of the displaying device, and comprises a touch pad, a support, a suspension device, and a plurality of sensing elements.

The touch pad detects the contact of objects to generate a first cursor signal. The support is mounted on the casing. The suspension device is connected to the touch pad as well as the support, and allows the touch pad to receive the force from being pushed, thereby causing temporary displacement with respect to the support. The sensing elements are respectively mounted on the support correspondingly to the perimeter of the touch pad to detect temporary displacement, thereby enabling a second cursor signal to be generated. The distance of the cursor movement in accordance with the second cursor signal is greater than the distance of the cursor movement in accordance with the first cursor signal shown on the displaying device.

According to the present invention, the touch pad device may be used in a portable electronic device with a displaying device. The touch pad device is used to control displacement of the cursor of the displaying device, and comprises a touch pad, a suspension device, and a plurality of sensing elements.

The touch pad is movable to detect the contact of objects to generate a first cursor signal. The suspension device is connected to the touch pad to suspend the touch pad. The sensing elements are respectively mounted correspondingly to the perimeter of the touch pad to detect temporary displacement, thereby enabling a second cursor signal to be generated. The distance of the cursor movement in accordance with the second cursor signal is greater than the distance of the cursor movement in accordance with the first cursor signal shown on the displaying device.

According to an embodiment of the present invention, a portable electronic device comprises a displaying device, a casing, and a touch pad device. The displaying device is used to display displacement of the cursor. The casing has an opening. The touch pad device is mounted on the casing to control displacement of the cursor of the displaying device, and comprises a touch pad, a support, a suspending device, and sensing elements. The touch pad is movable and exposed in the opening to detect the contact of objects to generate a first cursor signal. The support is mounted on the casing. The suspending device is connected to the touch pad as well as the support, and allows the touch pad to receive force from being pushed, thereby causing temporary displacement with respect to the support. The sensing elements are respectively mounted on the support correspondingly to the perimeter of the touch pad to detect temporary displacement, thereby enabling a second cursor signal to be generated. The distance of the cursor movement in accordance with the second cursor signal is greater than the distance of the cursor movement in accordance with the first cursor signal shown on the displaying device.

Therefore, the advantages of utilizing the touch pad device are as follows: the touch pad is non-fixed and movable; the suspending device suspends the touch pad making the touch pad a movable device; the cursor is able to quickly move in the direction the touch pad moves by using the sensing device, thereby increasing the convenience of application; particularly when moving the cursor in long distances, the touch pad can reduce the inconvenience brought by the need to drag a finger back and forth to move the cursor or scroll; furthermore, a movable touch pad can also increase a feeling of maneuverability.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is an exploded perspective view illustrating a portable electronic device according to an embodiment of the present invention.

FIG. 2 is a bottom view illustrating a touch pad device that may be used in the portable electronic device in FIG. 1.

FIG. 3 is an enlarged bottom view illustrating the touch pad device of the portable electronic device in FIG. 2.

FIG. 4 is a schematic view illustrating the operation of the touch pad device.

FIG. 5 is an enlarged cross-sectional view illustrating the touch pad device.

FIG. 6 is an enlarged cross-sectional view illustrating the operation of a sensing element of the touch pad device in FIG. 5.

### DETAILED DESCRIPTION OF THE PREFERRED EMBODIMENT

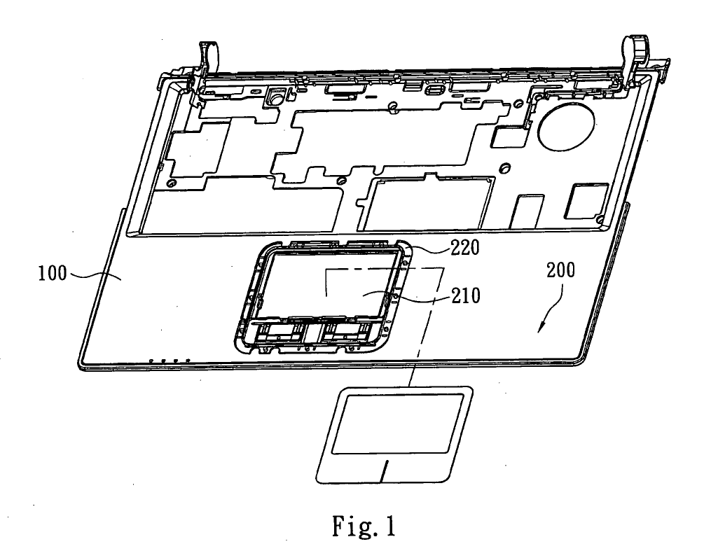

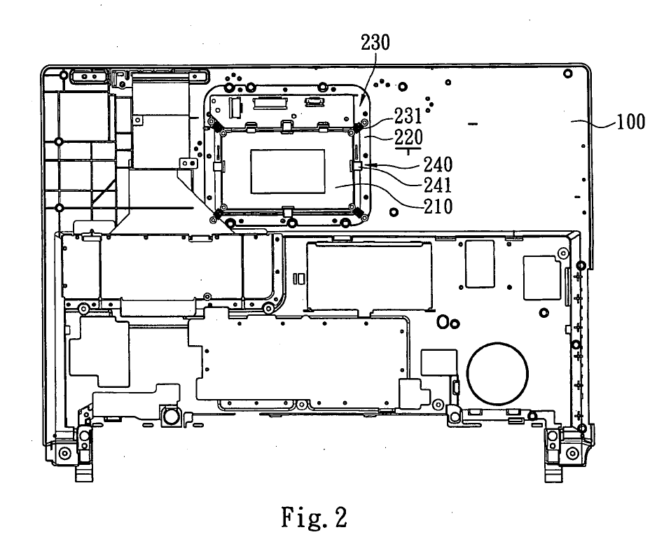

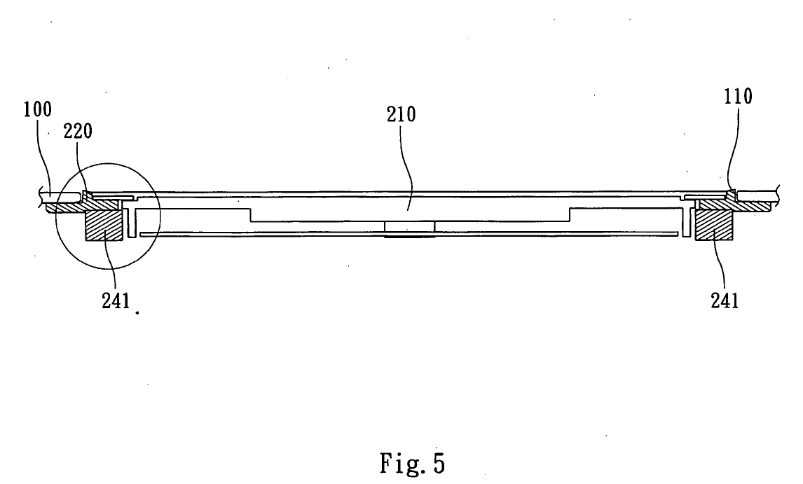

Referring to FIG. 1, FIG. 2, and FIG. 5, the portable electronic device, such as a portable computer, of an embodiment of the present invention comprises a casing 100, a displaying device, and a touch pad device 200. The casing 100 has an opening 110.

The touch pad device 200 is mounted on the casing 100 to control displacement of the cursor of the displaying device, such as a display screen, and comprises a touch pad 210, a support 220, a suspending device 230, and a sensing device 240. The touch pad 210 is movable as well as exposed in the opening 110, and detects the contact of objects, such as fingertips, to generate a first cursor signal.

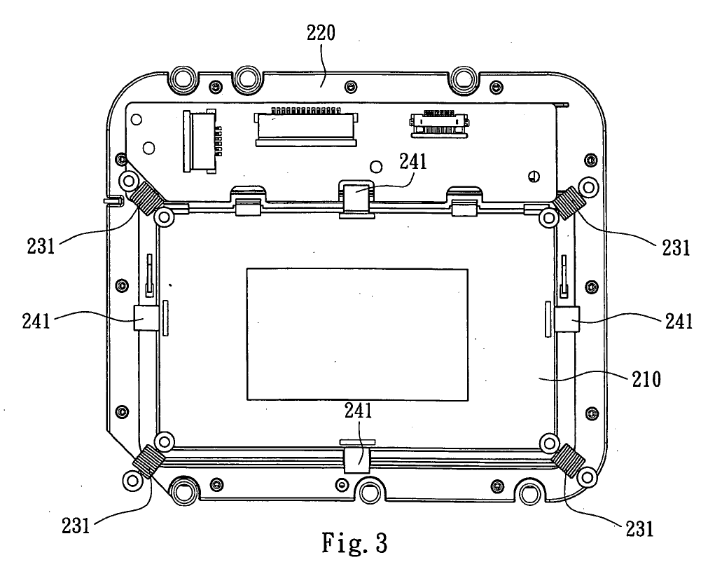

Referring to FIG. 3, the support 220 is mounted on the casing 100 to support the touch pad 210 and the suspending device 230. The suspending device 230 connects the touch pad 210 with the support 220 to suspend the touch pad 210. The suspending device 230 comprises a plurality of suspension elements 231. In an embodiment, the suspension elements 231 may be four resilient elements, such as springs, and are respectively connected to the four corners of the touch pad 210. Therefore, the suspending device 230 suspends the touch pad 210. When the touch pad 210 is pushed, the touch pad 210 can be moved with respect to the casing 100. Due to the suspending device 230, when the touch pad 210 receives force from being pushed, thereby causing temporary displacement with respect to the support 220. After the pushing force on the touch pad 210 is removed, the touch pad 210 can return to its initial position with respect to the support 220.

The sensing device 240 comprises a plurality of sensing elements 241. The sensing elements 241 are respectively mounted on the support 220 correspondingly to the perimeter of the touch pad 210. In an embodiment, the sensing device 240 comprises four sensing elements 241 that are respectively mounted at midpoint positions on the four edges of the touch pad 210. Each of the sensing elements 241 is a position sensor used to detect the amount of temporary displacement of the touch pad 210. When the sensing elements 241 detect temporary displacement, a second cursor signal is generated. The distance of the cursor movement in accordance with the second cursor signal is greater than the distance of the cursor movement in accordance with the first cursor signal shown on the displaying device.

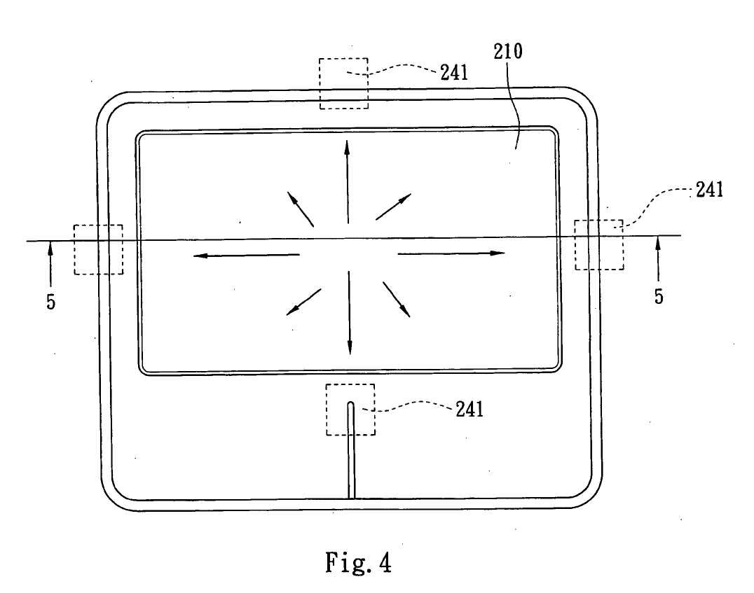

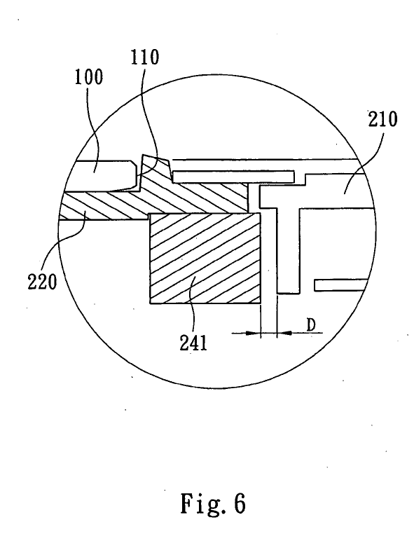

Referring to FIG. 4 and FIG. 6, when the touch pad 210 is pushed, the sensing elements 241 detect the amount of temporary displacement D of the touch pad 210, thereby generating a second cursor signal. Then second cursor signal is converted with a backend detecting process circuit so as to quickly move the cursor on the displaying device in the direction in response to the second cursor signal caused by the detection of the movements of the touch pad 210. The touch pad 210 is considerably convenient to use. In addition, the movable touch pad 210 also increases a feeling of maneuverability. Particularly when it is needed to drag the cursor in long distances, the users does not have to move or drag their fingers back and forth on the touch pad 210 to scroll or drag the cursor.

As is understood by a person skilled in the art, the foregoing preferred embodiments of the present invention are illustrated of the present invention rather than limiting of the present invention. It is intended to cover various modifications and similar arrangements included within the spirit and scope of the appended claims. Therefore, the scope of which should be accorded the broadest interpretation so as to encompass all such modifications and similar structure.

What is claimed is:

1. A touch pad device for a portable electronic device having a displaying device and a casing, adapted to control displacement of a cursor of the displaying device, and the touch pad device comprising:
a touch pad to detect a contact to generate a first cursor signal;
a support mounted on the casing;
a suspending device connected to the touch pad and the support to allow the touch pad to receive force from being pushed causing temporary displacement with respect to the support; and
a plurality of sensing elements respectively mounted on the support correspondingly to a perimeter of the touch pad, and the sensing elements detecting the temporary displacement enabling a second cursor signal to be generated;
wherein a distance of a cursor movement in accordance with the second cursor signal is greater than the distance of the cursor movement in accordance with the first cursor signal shown on the displaying device.

2. The touch pad device according to claim 1, wherein the suspending device comprises a plurality of suspending elements respectively mounted on four corners of the touch pad.

3. The touch pad device according to claim 2, wherein each of the suspending elements is a resilient element.

4. The touch pad device according to claim 3, wherein the resilient elements are springs.

5. The touch pad device according to claim 1, wherein the sensing elements respectively correspond with four edges of the perimeter of the touch pad.

6. The touch pad device according to claim 1, wherein each of the sensing elements is a position sensor to detect an amount of displacement of the touch pad.

7. A touch pad device for a portable electronic device having a displaying device, adapted to control displacement of a cursor of the displaying device, and the touch pad device comprising:
a touch pad that is movable to detect a contact to generate a first cursor signal;
a suspending device connected to the touch pad to suspend the touch pad; and
a plurality of sensing elements respectively mounted correspondingly to a perimeter of the touch pad to detect temporary displacement enabling a second cursor signal to be generated;
wherein a distance of a cursor movement in accordance with the second cursor signal is greater than the distance of the cursor movement in accordance with the first cursor signal shown on the displaying device.

8. The touch pad device according to claim 7, wherein the suspending device comprises a plurality of suspending elements respectively mounted on four corners of the touch pad.

9. The touch pad device according to claim 8, wherein each of the suspending elements is a resilient element.

10. The touch pad device according to claim 8, wherein the resilient elements are springs.

11. The touch pad device according to claim 7, wherein the sensing elements respectively correspond with four edges of the perimeter of the touch pad.

12. The touch pad device according to claim 7, wherein each of the sensing elements is a position sensor to detect an amount of displacement of the touch pad.

13. A portable electronic device comprising:
a displaying device to display displacement of a cursor;
a casing having an opening; and
a touch pad device mounted on the casing to control the displacement of the cursor of the displaying device, and comprising:
a touch pad that is movable and exposed in the opening to detect a contact to generate a first cursor signal;
a support mounted on the casing;
a suspending device connected to the touch pad and the support to allow the touch pad to receive force from being pushed causing temporary displacement with respect to the support; and
a plurality of sensing elements respectively mounted on the support correspondingly to a perimeter of the touch pad to detect the temporary displacement enabling a second cursor signal to be generated;
wherein a distance of a cursor movement in accordance with the second cursor signal is greater than the distance of the cursor movement in accordance with the first cursor signal shown on the displaying device.

14. The portable electronic device according to claim 13, wherein the suspending device comprises a plurality of suspending elements respectively mounted on four corners of the touch pad.

15. The portable electronic device according to claim 14, wherein each of the suspending elements is a resilient element.

16. The portable electronic device according to claim 15, wherein the resilient elements are springs.

17. The portable electronic device according to claim 13, wherein the sensing elements respectively correspond with four edges of the perimeter of the touch pad.

18. The portable electronic device according to claim 13, wherein each of the sensing elements is a position sensor used to detect an amount of displacement of the touch pad.

19. The portable electronic device according to claim 13, wherein the portable electronic device is a portable computer.
